(19) United States
(12) Patent Application Publication
(10) Pub. No.: US 2025/0378633 A1
(43) Pub. Date: Dec. 11, 2025

(54) Relightable 3D Reconstruction and View Synthesis

(71) Applicant: Google LLC, Mountain View, CA (US)

(72) Inventors: Philipp Henzler, San Francisco, CA (US); Ricardo Martin-Brualla, Seattle, WA (US); Xiaoming Zhao, Champaign, IL (US); Pratul Preeti Srinivasan, San Francisco, CA (US); Dor Verbin, San Francisco, CA (US); Keunhong Park, San Francisco, CA (US)

(21) Appl. No.: 19/230,885

(22) Filed: Jun. 6, 2025

Related U.S. Application Data
(60) Provisional application No. 63/656,972, filed on Jun. 6, 2024.

(51) Int. Cl. G06T 15/50; G06T 5/60; G06T 5/70; G06T 15/20

(52) U.S. Cl. CPC G06T 15/506; G06T 5/60; G06T 5/70; G06T 15/20; G06T 2207/20081; G06T 2207/20084

(57) ABSTRACT

Provided are systems and methods for relightable view synthesis that can process a set of source images captured under unknown lighting conditions to produce 3D reconstructions under novel target lighting and from novel viewpoints or poses. Initially, an example method includes obtaining source images and target lighting data, followed by generating radiance data using a source neural scene representation and a rendering engine. A machine-learned relighting diffusion model can then be employed to process the source images and radiance data to generate re-lit images. These images are subsequently used to train a latent neural radiance field model, which, upon querying following training, can generate synthetic images from novel poses under the target lighting. The proposed technology can be beneficial for applications in virtual reality, filmmaking, game development, and other settings, offering a robust alternative to traditional inverse rendering methods by leveraging advanced machine learning techniques to handle complex lighting scenarios.

### RELATED APPLICATIONS

This application claims priority to and the benefit of U.S. Provisional Patent Application No. 63/656,972, filed Jun. 6, 2024, and titled “RELIGHTABLE 3D RECONSTRUCTION AND VIEW SYNTHESIS”. U.S. Provisional Patent Application No. 63/656,972 is hereby incorporated by reference in its entirety.

### FIELD

The present disclosure relates generally to computer graphics and image processing. More particularly, the present disclosure relates to systems and methods for enhanced relightable three-dimensional reconstruction and view synthesis using neural radiance fields and diffusion models.

### BACKGROUND

An image can be broadly defined as a visual representation in the form of a two-dimensional array of pixels. Each pixel can contain values that represent the color and intensity of light at that point. Images can be used to capture or display visual information from the real world or a virtual world.

In the field of computer graphics and vision, relighting and novel view synthesis are tasks which aim to manipulate and reproduce images of scenes or objects under different lighting conditions and from various viewpoints that were not originally captured. Relighting involves altering the lighting of an image to simulate how the scene or object would appear under new light sources, while novel view synthesis generates new perspectives of the scene or object as if viewed from different camera positions. These capabilities can be used in virtual reality, filmmaking, and digital content creation, where flexible and realistic depiction of scenes is beneficial.

Traditional approaches to these tasks often rely on inverse rendering, a technique used to infer physical properties of a scene—such as geometry, surface materials, and lighting conditions—from a set of images, and then use this information to synthesize images under new conditions. However, this process presents several technical challenges. Inverse rendering is computationally expensive due to the need for differentiable Monte Carlo rendering, which requires extensive calculations to approximate integrals over complex lighting and material interactions. Furthermore, the process is inherently brittle and ambiguous; multiple combinations of geometry, materials, and lighting can explain a given set of input images, leading to potential inaccuracies when these inputs are used to generate views under novel lighting conditions and/or from novel viewpoints. These issues complicate the task and limit the efficiency and reliability of traditional methods in producing high-quality, relit, and novel-view images.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method for performing relightable view synthesis. The method includes obtaining, by a computing system comprising one or more computing devices, (i) a plurality of source images that depict a scene with a source lighting and (ii) target lighting data that describes a target lighting for the scene, the target lighting being different from the source lighting. The method includes generating, by the computing system and based on the plurality of source images, radiance data that represents radiance characteristics of the scene under the target lighting. The method includes respectively processing, by the computing system, the plurality of source images and the radiance data with a machine-learned relighting diffusion model to respectively generate a plurality of re-lit images that depict the scene with the target lighting. The method includes training, by the computing system, a latent neural radiance field model using the plurality of re-lit images. The method includes, after training latent neural radiance field model, querying, by the computing system, the latent neural radiance field model to generate a synthetic image that depicts the scene with the target lighting from a novel pose.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a data flow for an example technique for relightable view synthesis according to example embodiments of the present disclosure.

FIG. 2 depicts an example diffusion model architecture according to example embodiments of the present disclosure.

FIG. 3 depicts a flow chart diagram of an example method for relightable view synthesis according to example embodiments of the present disclosure.

FIG. 4A depicts a block diagram of an example computing system that performs relightable view synthesis according to example embodiments of the present disclosure.

FIG. 4B depicts a block diagram of an example computing device that performs relightable view synthesis according to example embodiments of the present disclosure.

FIG. 4C depicts a block diagram of an example computing device that performs relightable view synthesis according to example embodiments of the present disclosure.

Reference numerals that are repeated across plural figures are intended to identify the same features in various implementations.

### DETAILED DESCRIPTION

Generally, the present disclosure is directed to systems and methods for relightable view synthesis that can process a set of source images captured under unknown lighting conditions to produce 3D reconstructions under novel target lighting and from novel viewpoints or poses. Initially, an example method includes obtaining source images and target lighting data, followed by generating radiance data using a source neural scene representation and a rendering engine. A machine-learned relighting diffusion model can then be employed to process the source images and radiance data to generate re-lit images. These images are subsequently used to train a latent neural radiance field model, which, upon querying following training, can generate synthetic images from novel poses under the target lighting. The proposed technology can be beneficial for applications in virtual reality, filmmaking, game development, and other settings, offering a robust alternative to traditional inverse rendering methods by leveraging advanced machine learning techniques to handle complex lighting scenarios.

More particularly, a computing system can perform an example method for relightable view synthesis. The computing system can first obtain a plurality of source images depicting a scene with source lighting. The system can also obtain target lighting data describing a target lighting different from the source lighting. For example, the target lighting data can be provided by lighting simulation software or manually input by a user.

Scene lighting can refer to the distribution and characteristics of light sources within a scene that affect the appearance of objects captured in images. This includes aspects such as intensity, color, and direction of the light. Each of the source images can have been captured from a particular pose. In the context of imaging and graphics, a pose can refer to the specific orientation and position from which the scene is viewed or an image is captured.

Having obtained the source images and the target lighting data, the computing system can then generate radiance data that describes the radiance characteristics of the scene under the target lighting based on the plurality of source images. In particular, radiance data can include information that quantifies the amount of light that passes through or is emitted from a particular area within a scene and/or falls within a given solid angle. Thus, the radiance data can indicate how light interacts with surfaces. In some implementations of the present disclosure, this radiance data can be generated using a rendering engine that processes scene surface information derived from a source neural scene representation trained on the source images. For example, the radiance data can include renderings of the scene's surface geometry under the target lighting with various material characteristics.

The computing system can then use a machine-learned relighting diffusion model to process the plurality of source images and the radiance data to generate a plurality of re-lit images that depict the scene with the target lighting. For example, the computing system can use the machine-learned relighting diffusion model on a per-pose basis, where, for each pose contained in the set of source images, the diffusion model generates a re-lit image from that pose based on (e.g., conditioned upon) the source image from that pose and radiance data associated with (e.g., rendered from) that pose. A diffusion model is a type of generative machine learning model that progressively learns to transform noise into structured data, such as images, through a series of learned reverse diffusion steps. In some implementations, the relighting diffusion model can be trained using a relighting training dataset that includes training examples of source images, radiance cues, and corresponding re-lit images. These training examples can improve the model's ability to accurately produce re-lit images.

Once the plurality of re-lit images have been generated, the computing system can then train a latent neural radiance field model using the plurality of re-lit images. In some implementations, this training process can include initializing latent variable values for each re-lit image and jointly optimizing the parameter values of the latent neural radiance field model and the latent variable values. This method allows the model to effectively learn how to reconstruct the scene under the target lighting conditions from various viewpoints, where the latent variable represents different plausible interpretations of the scene under the target lighting conditions.

A neural radiance field, or NeRF, can be or include a neural network that learns to encode a volumetric scene function of a 3D space, which maps spatial coordinates and viewing directions to color and density. Neural radiance fields can be employed to synthesize novel views of complex scenes with high fidelity. A latent neural radiance field extends the concept of a traditional neural radiance field by incorporating latent variables that capture variations in scene properties that are not explicitly modeled, such as changes in lighting, material properties, or even different environmental conditions. This approach allows the neural radiance field to adapt its output—the synthesized images—based on these latent variables, thereby enabling more flexible and diverse generation of images from novel viewpoints under varying conditions.

In particular, after training, the latent neural radiance field model can be queried to generate synthetic images that depict the scene with the target lighting from novel poses. For example, querying the model can involve providing pose data describing the novel pose and a latent variable query value, which the model uses to render the synthetic image accurately reflecting the target lighting and scene geometry.

In some implementations, the source lighting in the present disclosure can include unknown lighting conditions, which adds complexity to the task of relighting. This scenario is common in real-world applications where the exact lighting conditions under which images were captured are not always known or controlled.

In some implementations, the described approach can also include generating a relighting training dataset using a set of three-dimensional rendering assets and a rendering engine. This dataset can be used for training the relighting diffusion model, providing it with diverse examples of source images, radiance cues, and re-lit images under varied lighting conditions.

Thus, example implementations of the present disclosure provide a comprehensive approach to relightable view synthesis, leveraging advanced machine learning models and rendering technologies to produce high-quality synthetic images of scenes under novel lighting conditions. This technology can be beneficial in various use cases, including content creation for digital media, simulation training environments, and architectural visualization. For example, the proposed approach can be used to generate simulated views of a scene on which further, downstream machine learning models can be trained.

The systems and methods of the present disclosure provide a number of technical effects and benefits. As one example, the proposed technology enhances the consistency and plausibility of 3D renderings from novel viewpoints under varied lighting conditions. In particular, traditional methods rely on inverse rendering, which is brittle due to its dependence on differentiable Monte Carlo rendering. These methods often struggle with the inherent ambiguity of determining the correct geometry, materials, and lighting from a given set of images, leading to potential inaccuracies in renderings under unobserved illumination. In contrast, the proposed approach utilizes a 2D relighting diffusion model to generate multiple plausible relit images for each viewpoint. These images are then used to train a latent neural radiance field, which effectively reconciles the variations into a consistent 3D model. This approach mitigates the ambiguity associated with inverse rendering, resulting in more reliable and geometrically-consistent renderings that maintain visual fidelity across different lighting scenarios.

As another example technical effect, the proposed approach significantly reduces computational expenditure by circumventing the traditional inverse rendering process, which typically involves complex and resource-intensive differentiable Monte Carlo rendering. Instead, by utilizing a 2D relighting diffusion model to generate relit images, followed by the training of a latent neural radiance field, the method efficiently processes multiple plausible lighting scenarios without the need for extensive optimization of geometry, materials, and lighting variables. This streamlined process not only lessens the computational load but also accelerates the overall workflow, enabling faster and more resource-effective generation of high-quality 3D renderings from novel viewpoints under various lighting conditions. This reduction in computational resources provides a substantial benefit, particularly in fields requiring rapid and reliable 3D visualization and analysis.

As another example technical effect, the proposed approach offers distinct technical advantages in handling complex 3D relighting scenarios. In particular, unlike possible alternative approaches which focus on single-image relighting using a monocular depth network for geometry estimation, the proposed method leverages multiple images of an object and employs advanced surface reconstruction techniques to estimate geometry. This allows for a more accurate and detailed modeling of the object's physical characteristics, enhancing the ability to capture and simulate intricate light transport effects, such as interreflections caused by occluded geometry. Consequently, this approach provides more realistic and accurate renderings under diverse lighting conditions.

The proposed technology can be applied to a wide array of use cases across different industries where accurate and dynamic 3D visualization is beneficial. For example, in the field of virtual reality (VR) and augmented reality (AR), the technology can take input images of real-world environments under specific lighting conditions and output immersive 3D scenes that users can explore under various lighting scenarios, enhancing the realism and interactivity of VR and AR applications. As another example, in the film and entertainment industry, production teams can input images of set pieces or locations captured under natural lighting, and the technology can output the same scenes relit to match different times of day or weather conditions, aiding in visual effects planning and execution. As yet another example, in architectural visualization, architects or other home design individuals or tools can input photographs of building interiors or models, and receive outputs showing the spaces under different lighting conditions, helping users make informed decisions about lighting design and material choices. Each of these use cases benefits from the technology's ability to quickly and accurately simulate realistic lighting on 3D objects from any viewpoint, streamlining creative workflows and enhancing end-user experiences.

### Example Problem Formulation

Given a dataset of images of an object and corresponding camera poses D={(I_i, π_i)} _{i=1 to N}, one goal of relightable 3D reconstruction is to estimate a model with parameters θ that when rendered, produces relit versions of the dataset under unobserved target illumination L\hat{ }T. This can be expressed as:

$${θ}^{*} = argmax\_θ p ( D\_θ ⋀ T \vert D ) , \qquad ( 1 )$$

where D_θ\hat{ }T ≙{(relight (D, L\hat{ }T, π_i, θ), π_i)} _{i=1 to N} is a relit version of the original dataset under target illumination L\hat{ }T using model θ. Note that Eq. (1) only maximizes the likelihood of the original given poses after relighting. However, by using view synthesis, example implementations of the present disclosure can then turn the collection of relit images into a 3D representation which can be rendered from arbitrary poses. For brevity, the remainder of this discussion therefore omits the implicit dependence of D\hat{ }T in θ.

This relighting problem has traditionally been solved by using inverse rendering. Inverse rendering techniques do not maximize the probability of the relit renderings, but instead recover a single point estimate of the most likely scene geometry G, materials M, and lighting L (note that this is the “source” lighting condition for the observed images) that together explain the input dataset, and then use physically-based rendering to relight this factorized explanation under the target lighting. Inverse rendering seeks to recover θ\hat{ }IR=(G*, M*), where:

$${G}^{*} , {M}^{*} , {L}^{*} = argmax\_ \{ G , M , L \} p \{ G , M , L \vert D ) = argmax\_ \{ G , M , L \} p ( D \vert G , M , L ) p ( G , M , L ) . \qquad ( 2 )$$

The first data likelihood term is computed by physics-based rendering of the estimated model and the second prior term is often factorized into separate handcrafted priors on geometry, materials, and lighting.

A relighting approach based on inverse rendering then renders each image I in D corresponding to camera pose π using the recovered geometry and materials, illuminated by the target lighting L\hat{ }T, resulting in relight (D, L\hat{ }T, π, θ\hat{ }IR).

This approach has three main issues. First, the differentiable rendering procedures used to compute the gradient of the likelihood term are computationally-expensive. Second, it requires careful modeling of light transport which is cumbersome and existing differentiable renderers do not account for many types of lighting arid material effects seen in the real world. Third, there are often ambiguities between M and L, meaning that any errors in their decomposition may be apparent in the relit data. It is quite difficult to design effective handcrafted priors on geometry, materials, and lighting, so inverse rendering procedures frequently recover explanations that have a high data likelihood (are able to render the observed data) but produce clearly incorrect results when re-rendered under different illumination.

### Overview of Example Model

Example implementations of the present disclosure can maximize the probability of relit images in Eq. (1) without using an explicit physically-based model of the object's lighting or materials. First, consider a latent variable Z that can be thought of as implicitly representing the input images' lighting along with the object's material and geometry parameters. The likelihood of the relit data can be written as:

$$p ( D ⋀ T \vert D ) = \int p ( D ⋀ T , Z \vert D ) dZ = \int p ( D ⋀ T \vert Z , D ) p ( Z \vert D ) dZ . \qquad ( 3 )$$

Introducing these latent variables enables consideration of all relit renderings in the dataset, D\hat{ }T_i ≙(I\hat{ }T_i, π_i), as conditionally independent, since the rendering under the target lighting L\hat{ }T is deterministic given the object's geometry and materials. This enables writing the likelihood as:

$$p ( D ⋀ T \vert D ) = \int ( [ product\_ \{ i = 1 to N \} p ( D ⋀ T\_i \vert Z\_i , D\_i ) ] \{ latent NeRF \} ⋆ p ( Z \vert D ) \{ latent prior \} ) d Z . \qquad ( 4 )$$

Example implementations of the present disclosure model this with a latent NeRF model that is able to render novel views under the target illumination for any sampled latent vector. This NeRF model can be trained by generating a large quantity of sampled relit images with the same target lighting but with different (unknown) latent vectors using a relighting diffusion model. In this way, the latent NeRF model effectively distills a large dataset of relit images sampled by the diffusion model into a single 3D representation that can render novel views of the object under the target lighting for any sampled latent.

### Example Latent NeRF Model

Example implementations of the present disclosure can model the distribution in Eq. (4) in a manner that enables rendering images that correspond to relit views of the object for any sampled latent Z. Some example implementations model this with a latent code NeRF 3D representation. This example latent NeRF optimizes a set of latent codes that are used to condition the view-dependent color function represented by the NeRF, enabling it to render novel views of the relit object under the target illumination for any sampled latent code. In some implementations, the latent NeRF's geometry does not depend on the latent code, so the latent code may be interpreted as only representing the object's material properties.

To optimize the parameters θ of the latent NeRF model, some example implementations maximize the log-likelihood, which by using Eq. (4), can be written as the following maximization problem:

$${θ}^{*} = argmax\_θ log p ( D\_θ ⋀ T \vert D ) = argmax\_θ log \int [ product\_ \{ i = 1 to N \} p ( D ⋀ T\_i \vert Z\_i , D\_i ) ] p ( Z \vert D ) dZ . \qquad ( 5 )$$

Because integrating over all possible latents Z is intractable, some example implementations use a heuristic inference strategy and replace the integral with the maximum a posteriori (MAP) estimate of Z:

$${θ}^{*} = argmax\_θ max\_Z {\sum }_{-} \{ i = 1 to N \} log p ( D ⋀ T\_i \vert Z\_i , D\_i ) + log p ( Z \vert D ) . \qquad ( 6 )$$

By assuming a Gaussian model over the data given the materials, the first term in Eq. (6) is a reconstruction loss over the images. However, since some example implementations do not have access to the true latent vector Z, some example implementations assume a uniform prior over them, turning the second term in Eq. (6) into a constant. In practice, similar to prior work on NeRFs optimized to generate new views given a dataset containing images with varying appearance, some example implementations can rely on the NeRF model to resolve any mismatches in the appearance of different images.

The minimization of the negative log-likelihood can then be written as:

$${θ}^{*} = argmin\_θ min\_Z {\sum }_{-} i \{ = 1 to N \} ‖ D ⋀ T\_i - latent - NeRF ( 0 , Z\_i , π\_i ) ‖ ⋀ 2. \qquad ( 7 )$$

### Example Relighting Diffusion Model

In order to train the latent NeRF model described in the subsection above, some example implementations use a Relighting Diffusion Model (RDM) to generate S samples for each viewpoint from p (D\hat{ }T_i|D_i). In other words, given an input image and target lighting L\hat{ }T, the single-image RDM samples S images corresponding to relit versions of D_i that have a high likelihood given the new target light L\hat{ }T. Some example implementations then associate each sample s∈{1, . . . , S} with its own latent code Z_{i,s} and sum over all samples when training the latent NeRF (Eq. (7)).

One example RDM can be implemented as an image denoising diffusion model that is conditioned by the input image and target lighting. To encode the target lighting, some example implementations use image-space radiance cues. These radiance cues can be generated by using a simple shading model to render a handful of images of the object's estimated geometry under the target lighting. This procedure is designed to provide information about the effects of specularities, shadows, and global illumination, without requiring the diffusion network to learn these effects from scratch. Some example implementations use four different pre-defined materials to render radiance cues: one diffuse material with a pure white albedo, and three purely-specular materials with roughness values (e.g., {0.05, 0.13, 0.34}).

The RDM architecture can include a pretrained latent image diffusion model, and can use a ControlNet-based approach to condition on the radiance cues.

### Visualization of Example Framework

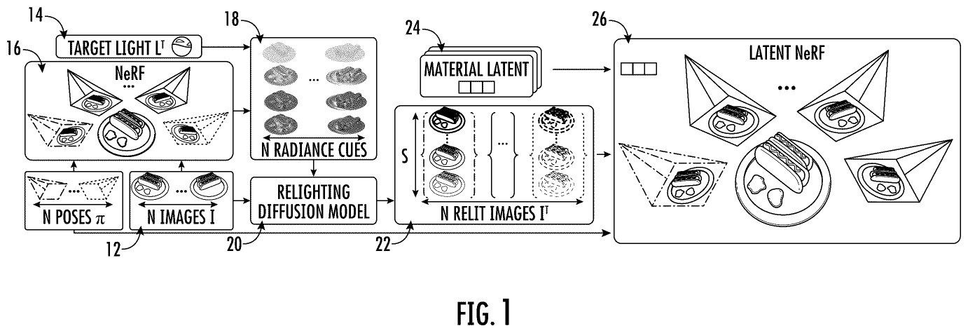

Referring now to FIG. 1, a block diagram of the data flow for an example technique for relightable view synthesis is depicted according to example embodiments of the present disclosure. The process begins with obtaining a plurality of source images 12 captured from various poses, depicted as “N Poses π” and “N Images I”. In some implementations, these images are captured under a source lighting which is not predefined, making the lighting conditions unknown.

FIG. 1 also illustrates target lighting data 14, which describes a desired lighting condition different from the source lighting. This target lighting data 14 can be fed into a source neural scene representation 16, for example which may have been trained on the source images 12. The source neural scene representation 16 can use the target lighting data 14 (and its learned representation of the scene learned from source images 12) to generate radiance cues 18. These radiance cues can describe how light interacts with the surfaces within the scene under the new lighting conditions.

In some implementations, the source neural scene representation 16 can be implemented as or using a UniSDF model. UniSDF is a Signed Distance Function (SDF)-based approach, which allows for the derivation of a mesh from the SDF. In some implementations, radiance cues 18 are extracted by optimizing UniSDF on input images, converting the SDF representation to a mesh, and using Blender Cycles to render these cues under target illumination with predefined materials to simulate different lighting effects. In some implementations, to enhance the quality of the radiance cues, shading normals can be smoothed by feeding MLP-predicted normals into Blender, which uses its shading normal smoothing function to produce more accurate renderings that reflect lighting conditions faithfully.

Referring still to FIG. 1, The radiance cues 18 and the source images 12 can then be input into the relighting diffusion model 20. This model can process each combined input to generate a plurality of re-lit images 22, denoted as “N Relit images IT”. Each re-lit image represents a version of the source image as it would appear under the target lighting conditions. The diffusion model has learned to transform the appearance of the scene to reflect the new lighting scenario without the need for explicit physical modeling of light interactions.

In some implementations, the diffusion model 20 includes a pretrained latent image diffusion model. For example, in some implementations, the architecture of the relighting diffusion model 20 is based on a latent image diffusion model, modified with a trainable UNet encoder and middle block, and supplemented by a ZeroConv-based decoder to process radiance cues and input images effectively.

In some implementations, training data for the diffusion model 20 can have been prepared using the Objaverse dataset, filtering out low-quality and semi-transparent objects, and rendering pairs of images under different lighting conditions using Blender's Cycle path tracer to create diverse training examples.

Referring still to FIG. 1, in some implementations, the re-lit images 22 are further assigned latent variable values 24, which represent material properties inferred from the relit images. These latent values can be used to train a latent neural radiance field 26. In some implementations, the parameters of the latent neural radiance field 26 can be optimized using a log-likelihood maximization approach, which includes handling latent variables and minimizing reconstruction loss.

Once trained, the latent neural radiance field 26 is capable of rendering synthetic images from novel viewpoints under the target lighting conditions, effectively creating a dynamic and flexible 3D model of the scene that can be viewed from any angle and under any lighting condition specified by the target lighting data.

This system provides a robust solution to the challenges of relightable view synthesis, particularly in scenarios where the original lighting conditions are unknown or where it is desirable to visualize objects under different lighting conditions. The use of a diffusion model for generating re-lit images allows for a flexible, data-driven approach that avoids the complexities and computational costs associated with inverse rendering techniques.

### Example Model Architecture

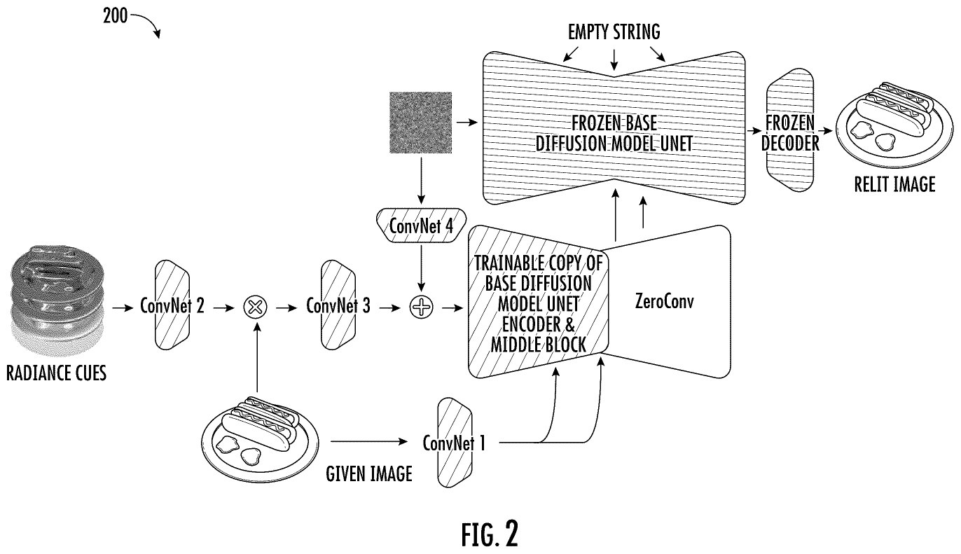

Referring now to FIG. 2, a diagrammatic representation of one possible example diffusion model architecture 200 is depicted according to example embodiments of the present disclosure. This figure illustrates the workflow and component interaction within the relighting diffusion model, which generates re-lit images from given images under target lighting conditions.

The architecture begins with the input of a “Given Image” and “Radiance Cues.” The Given Image represents a scene captured under source lighting conditions. The Radiance Cues, which may be generated from the scene's geometry under target lighting using predefined materials, provide information about how light interacts with the surfaces within the scene. These cues are processed through a series of convolutional networks to extract features relevant to the lighting conditions.

The features extracted from the Radiance Cues can be combined with features from the Given Image (e.g., as processed by ConvNet 1) using a “Trainable Copy of Base Diffusion Model UNet Encoder & Middle Block.” This component can be a modified version of a standard UNet architecture, which has been adapted to specifically handle the nuances of image relighting by learning to incorporate lighting variations effectively.

A “Frozen Base Diffusion Model UNet,” which can in some implementations receive an “Empty String” to ensure the model operates in a purely image-based mode, processes the output from the trainable encoder and middle block and also a set of input noise.

A final component in the architecture is the “Frozen Decoder” block, which acts as a decoder. This component takes the processed features from the Frozen Base Diffusion Model UNet and reconstructs the image data into a re-lit image that reflects the target lighting conditions.

### Example Methods

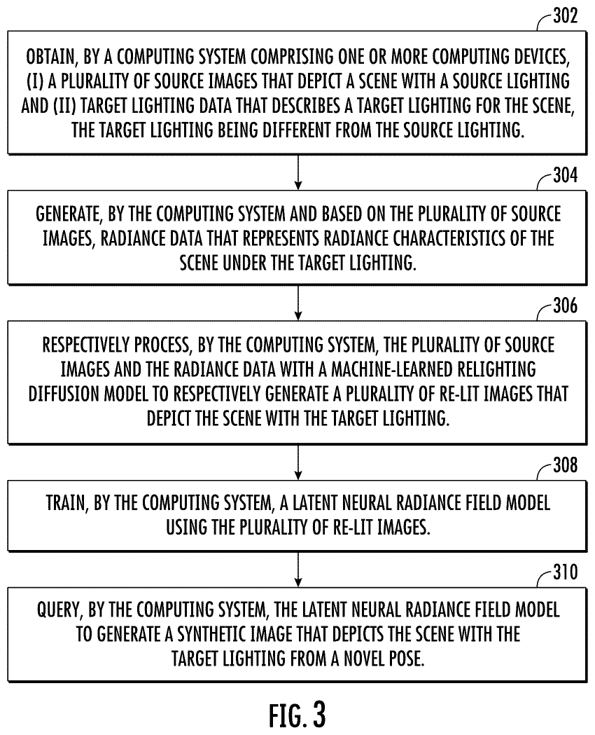

Referring now to FIG. 3, a flowchart illustrates the method for performing relightable view synthesis using the disclosed technology. Step 302 can include obtaining, by the computing system, a plurality of source images 12 that depict a scene with source lighting and target lighting data 14 that describes a target lighting for the scene, which differs from the source lighting.

In step 304, the computing system generates radiance data that describes the radiance characteristics of the scene under the target lighting. This radiance data can be derived from the plurality of source images 12 and the target lighting data 14. The radiance data can provide information on how light interacts with the scene's surfaces under the new lighting conditions.

At step 306, the computing system processes the plurality of source images and the radiance data with a machine-learned relighting diffusion model 20. This model uses advanced diffusion techniques to generate a plurality of re-lit images 22 that depict the scene illuminated by the target lighting. Each re-lit image represents a potential version of the scene as it would appear under the new lighting conditions, thus offering various interpretations that enhance the robustness and diversity of the synthesis process.

Following the generation of re-lit images, step 308 includes training a latent neural radiance field model 26 using these images. The training process can include initializing and optimizing latent variable values 24, which represent different plausible interpretations of the scene under the target lighting conditions. This model learns to effectively reconstruct the scene's 3D representation from various viewpoints, adapting its output based on the latent variables.

Finally, step 310 includes querying the trained latent neural radiance field model by the computing system to generate a synthetic image from a novel pose. This synthetic image accurately reflects the target lighting and scene geometry, demonstrating the model's ability to synthesize high-fidelity views of the scene from perspectives that were not originally captured.

### Example Devices and Systems

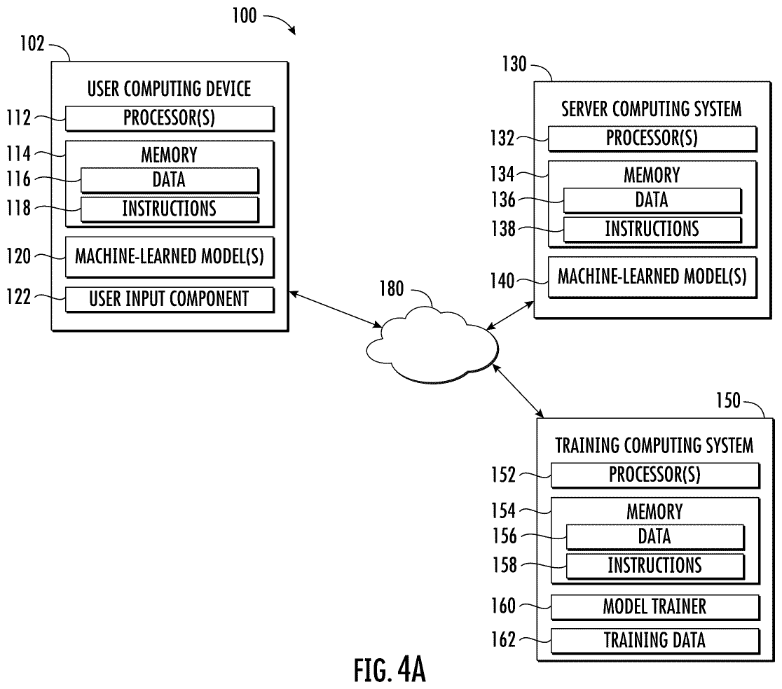

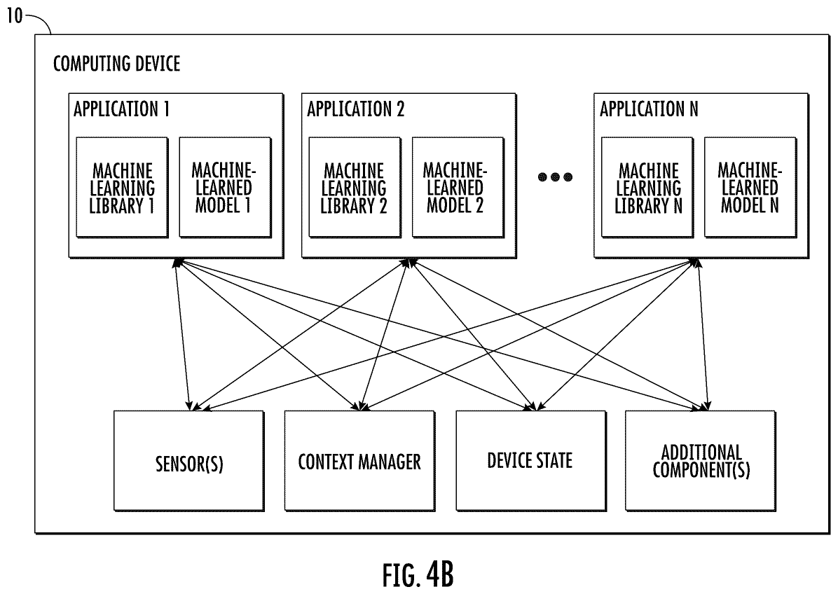

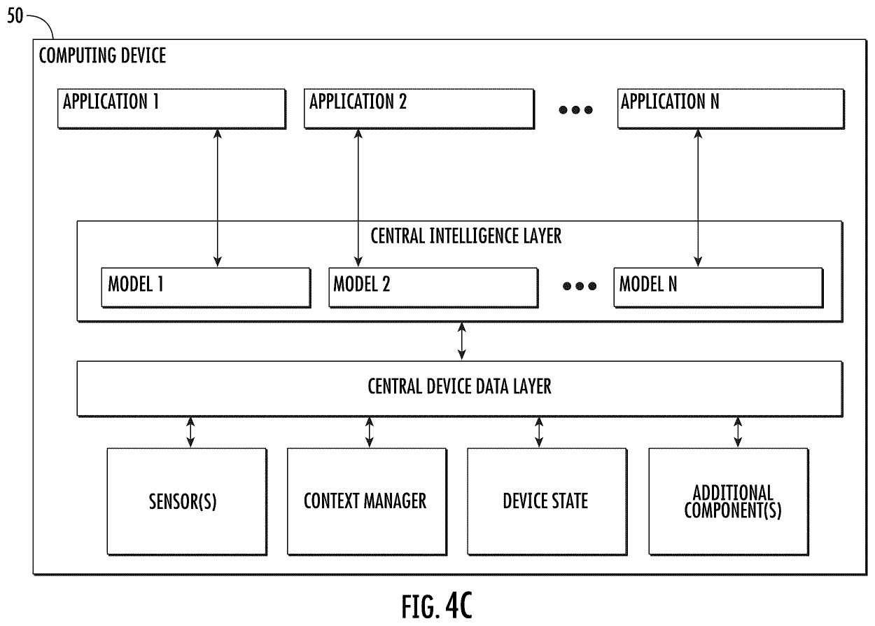

FIG. 4A depicts a block diagram of an example computing system 100 that performs relightable view synthesis according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

In some implementations, the user computing device 102 can store or include one or more machine-learned models 120. For example, the machine-learned models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models). Machine-learned models 120 can include or be used to effectuate neural scene representations such as neural radiance fields and/or denoising diffusion models. Example machine-learned models 120 are discussed with reference to FIGS. 1-3.

In some implementations, the one or more machine-learned models 120 can be received from the server computing system 130 over network 180, stored in the user computing device memory 114, and then used or otherwise implemented by the one or more processors 112. In some implementations, the user computing device 102 can implement multiple parallel instances of a single machine-learned model 120 (e.g., to perform parallel relightable view synthesis across multiple instances of inputs).

Additionally or alternatively, one or more machine-learned models 140 can be included in or otherwise stored and implemented by the server computing system 130 that communicates with the user computing device 102 according to a client-server relationship. For example, the machine-learned models 140 can be implemented by the server computing system 140 as a portion of a web service (e.g., a view synthesis service). Thus, one or more models 120 can be stored and implemented at the user computing device 102 and/or one or more models 140 can be stored and implemented at the server computing system 130.

The user computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). Machine-learned models 140 can include or be used to effectuate neural scene representations such as neural radiance fields and/or denoising diffusion models. Example models 140 are discussed with reference to FIGS. 1-3.

One example type of machine learning model (e.g., model 120 and/or 140) is a denoising diffusion model (or “diffusion model”). A denoising diffusion model can be defined as a type of generative model that learns to progressively remove noise from a set of input data to generate new data samples. A comprehensive discussion of diffusion models is provided by Yang L., Zhang Z., Song Y., Hong S., Xu R., Zhao Y., Zhang W., Cui B., and Yang M., Diffusion Models: A Comprehensive Survey of Methods and Applications, arXiv: 2209.00796 [cs.LG]. See also, Sohl-Dickstein, J., Weiss, E., Maheswaranathan, N., & Ganguli, S. (2015). Deep Unsupervised Learning using Nonequilibrium Thermodynamics. In International Conference on Machine Learning (ICML); Song, Y., & Ermon, S. (2019). Generative Modeling by Estimating Gradients of the Data Distribution. In Advances in Neural Information Processing Systems (NeurIPS); Ho, J., Jain, A., & Abbeel, P. (2020). Denoising Diffusion Probabilistic Models. In Advances in Neural Information Processing Systems (NeurIPS); and Song, Y., Sohl-Dickstein, J., Kingma, D. P., Kumar, A., Ermon, S., & Poole, B. (2020). Score-Based Generative Modeling through Stochastic Differential Equations. In International Conference on Learning Representations (ICLR).

More particularly, in some implementations, the diffusion process of a denoising diffusion model can include both forward and reverse diffusion phases. The forward diffusion phase can include gradually adding noise (e.g., Gaussian noise) to data over a series of time steps. This transformation can lead to the data eventually resembling pure noise. For example, in the context of image processing, an initially clear image can incrementally receive noise until it is indistinguishable from random noise. In some implementations, this step-by-step addition of noise can be parameterized by a variance schedule that controls the noise level at each step.

Conversely, the reverse diffusion phase can include systematically removing the noise added during the forward diffusion to reconstruct the original data sample or to generate new data samples. This phase can use a trained neural network model to predict the noise that was added (or conversely, that should be removed) at each step and subtract it from the noisy data. For instance, starting from a purely noisy image, the model can iteratively denoise the image, progressively restoring details until a clear image is obtained.

This process of reverse diffusion can be guided by learning from a set of training data, where the model learns the optimal way to remove noise and recover data. The ability to reverse the noise addition effectively allows the generation of new data samples that are similar to the training data and/or modified according to specified conditions. In particular, in the learned reverse diffusion process, the diffusion model can be used to generate new samples that can either replicate the original or produce variations based on the learned data distribution.

In some implementations, denoising diffusion models can operate in either pixel space or latent space, each offering distinct advantages depending on the application requirements. Operating in pixel space means that the model directly manipulates and generates data in its original form, such as raw pixel values for images. For example, when generating images, the diffusion process can add or remove noise directly at the pixel level, allowing the model to learn and reproduce fine-grained details that are visible in the pixel data.

Alternatively, operating in latent space can include transforming the data into a compressed, abstract representation before applying the diffusion process. This can be beneficial for handling high-dimensional data or for improving the computational efficiency of the model. For instance, an image can be encoded into a lower-dimensional latent representation using an encoder network, and the diffusion process can then be applied in this latent space. The denoised latent representation can subsequently be decoded back into pixel space to produce the final output image. This approach can reduce the computational load during the training and sampling phases and can sometimes help in capturing higher-level abstract features of the data that are not immediately apparent in the pixel space.

In some implementations, denoising diffusion models can utilize probability distributions to manage the transformation of data throughout the diffusion process. As one example, Gaussian distributions can be employed in the forward diffusion phase, where noise added to the data is typically modeled as Gaussian. This method can be beneficial for applications like image processing or audio synthesis, where the gradual addition of Gaussian noise helps in creating a smooth transition from original data to a noise-dominated state. However, the model can also be designed to use other types of noise distributions as part of its stochastic process.

In the reverse phase, learned transition distributions can guide the denoising steps. Specifically, a parameterized model (e.g., neural network) can be used to predict the noise to be removed at each step of the reverse phase.

Model parameters can refer to parameter values within the denoising diffusion model that can be learned from training data to optimize the performance of the denoising diffusion model. These parameters can include weights of the neural networks used to predict noise in the reverse diffusion process, as well as parameters defining the noise schedule in the forward process.

The architecture of an example denoising diffusion model can include one or more neural networks. The neural networks can be trained to parameterize the transition kernels in the reverse Markov chain. As examples, the architecture of a denoising diffusion model can incorporate various types of neural networks, such as Convolutional Neural Networks (CNNs) or Recurrent Neural Networks (RNNs).

As a specific example, in some implementations, the neural network architecture can take the form of a U-Net. The U-Net architecture is characterized by its U-shaped structure, which includes a contracting path and an expansive path. The contracting path follows the typical architecture of a convolutional network, including repeated application of convolutions, followed by pooling operations that reduce the spatial dimensions of the feature maps. The expansive path of the U-Net, on the other hand, can include a series of up-convolutions and concatenations with high-resolution features from the contracting path. This can be achieved through skip connections that directly connect corresponding layers in the contracting path to layers in the expansive path.

More generally, the neural network architecture in denoising diffusion models can include multiple layers that can include various types of activation functions. These functions introduce non-linearities that enable the network to capture and learn complex data patterns effectively, although the specific choices of layers and activations can vary based on the model design and application requirements.

Additionally, the architecture can include special components like residual blocks and attention mechanisms, which can enhance the model's performance. Residual blocks can help in training deeper networks by allowing gradients to flow through the network more effectively. Attention mechanisms can provide a means for the model to focus on specific parts of the input data, which is advantageous for applications such as language translation or detailed image synthesis, where contextual understanding significantly impacts the quality of the output. These components are configurable and can be integrated into the neural network architecture to address specific challenges posed by the complexity of the data and the requirements of the generative task.

In some implementations, the training process of a denoising diffusion model can be oriented towards specific learning objectives. These objectives can include minimizing the difference between the original data and the data reconstructed after the reverse diffusion process. Specifically, in some implementations, an objective can include minimizing the Kullback-Leibler divergence between the joint distributions of the forward and reverse Markov chains to ensure that the reverse process effectively reconstructs or generates data that closely matches the training data. As another example, in image processing applications, the objective may be to minimize the pixel-wise mean squared error between the original and reconstructed images. Additionally, the model can be trained to optimize the likelihood of the data given the model, which can enhance the model's ability to generate new samples that are indistinguishable from real data.

Various strategies can be used to perform the training process for diffusion models. Gradient descent algorithms, such as stochastic gradient descent (SGD) or Adam, can be utilized to update the model's parameters. Moreover, learning rate schedules can be implemented to adjust the learning rate during training, which can help in stabilizing the training process and improving convergence. For instance, a learning rate that decreases gradually as training progresses can lead to more stable and reliable model performance.

Various loss functions can be used guide the training of denoising diffusion models. Example loss functions include the mean squared error (MSE) for regression tasks or cross-entropy loss for classification tasks within the model. Additionally, variational lower bounds, such as the evidence lower bound (ELBO), can be used to train the model under a variational inference framework. These loss functions can help in quantifying the discrepancy between the generated samples and the real data, guiding the model to produce outputs that closely resemble the target distribution.

In some implementations, temperature sampling in denoising diffusion models can be used to control the randomness of the generation process. By adjusting the temperature parameter, one can modify the variance of the noise used in the sampling steps, which can affect the sharpness and diversity of the generated outputs. For instance, a lower temperature can result in less noisy and more precise samples, whereas a higher temperature can increase sample diversity but may also introduce more noise and reduce sample quality.

In some implementations, conditional generation can allow the generation of data samples based on specific conditions or attributes. Conditional generation in denoising diffusion models can include modifying the reverse diffusion process based on additional inputs (e.g., conditioning inputs) such as class labels or text descriptions, which guide the model to generate data samples that are more likely to meet specific conditions. This can be implemented by conditioning the model on additional inputs such as class labels, text descriptions, or other data modalities. For example, in a model trained on a dataset of images and their corresponding captions, the model can generate images that correspond to a given textual description, enabling targeted image synthesis.

More particularly, denoising diffusion models can be conditioned using various types of data to guide the generation process towards specific outcomes. One common type of conditioning data is text. For example, in generating images from descriptions, the model can use textual inputs like “a sunny beach” or “a snowy mountain” to generate corresponding images. The text can be processed using natural language processing techniques to transform it into a format that the model can utilize effectively during the generation process.

For example, one type of conditioning data can include text embeddings. Text embeddings are vector representations of text that capture semantic meanings, which can be derived from pre-trained language models such as BERT or CLIP. These embeddings can provide a denser and potentially more informative representation of text than raw text inputs. For instance, in a diffusion model tasked with generating music based on mood descriptions, embeddings of words like “joyful” or “melancholic” can guide the audio generation process to produce music that reflects these moods.

Additionally, conditioning can also include using categorical labels or tags. This approach can be particularly useful in scenarios where the data needs to conform to specific categories or classes.

Classifier-free guidance is a technique that can enhance the control over the sample generation process without the need for an additional classifier model. This can be achieved by modifying the guidance scale during the reverse diffusion process, which adjusts the influence of the learned conditional model. For instance, by increasing the guidance scale, the model can produce samples that more closely align with the specified conditions, improving the fidelity of generated samples that meet desired criteria without the computational overhead of training and integrating a separate classifier.

In some implementations, denoising diffusion models can integrate with other generative models to form hybrid models. For instance, combining a denoising diffusion model with a Generative Adversarial Network (GAN) can leverage the strengths of both models, where the diffusion model can ensure diversity and coverage of the data distribution, and the GAN can refine the sharpness and realism of the generated samples. Another example can include integration with Variational Autoencoders (VAEs) to improve the latent space representation and stability of the generation process.

Efficiency improvements are beneficial aspects of denoising diffusion models. One way to achieve this is by reducing the number of diffusion steps required to generate high-quality samples. For example, sophisticated training techniques such as curriculum learning can be employed to gradually train the model on easier tasks (fewer diffusion steps) and increase complexity (more steps) as the model's performance improves. Additionally, architectural optimizations such as implementing more efficient neural network layers or utilizing advanced activation functions can decrease computational load and improve processing speed during both training and generation phases.

Noise scheduling strategies can improve the performance of denoising diffusion models. By carefully designing the noise schedule—the variance of noise added at each diffusion step—models can achieve faster convergence and improved sample quality. For example, using a learned noise schedule, where the model itself optimizes the noise levels during training based on the data, can result in more efficient training and potentially better generation quality compared to fixed, predetermined noise schedules.

In some implementations, learned upsampling in denoising diffusion models can facilitate the generation of high-resolution outputs from lower-resolution inputs. This technique can be particularly useful in applications such as high-definition image generation or detailed audio synthesis. Learned upsampling can include additional model components that are trained to increase the resolution of generated samples through the reverse diffusion process, effectively enhancing the detail and quality of outputs without the need for externally provided high-resolution training data. In some cases, these additional learned components can be referred to as “super-resolution” models.

In some implementations, denoising diffusion models can be applied to the field of image synthesis, where they can generate high-quality, photorealistic images from a distribution of training data. For example, example models can be used to create new images of landscapes, animals, or even fictional characters by learning from a dataset composed of similar images. The model can add noise to these images and then learn to reverse this process, effectively enabling the generation of new, unique images that maintain the characteristics of the original dataset.

Denoising diffusion models can also be utilized in audio generation. They can generate clear and coherent audio clips from noisy initial data or even from scratch. For instance, in the music industry, example models can help in creating new musical compositions by learning from various genres and styles. Similarly, in speech synthesis, denoising diffusion models can generate human-like speech from text inputs, which can be particularly beneficial for virtual assistants and other AI-driven communication tools.

Other potential use cases of denoising diffusion models extend across various fields including drug discovery, where example models can help in generating molecular structures that could lead to new pharmaceuticals. Additionally, in the field of autonomous vehicles, denoising diffusion models can be used to enhance the processing of sensor data, improving the vehicle's ability to interpret and react to its environment.

In some implementations, the performance of denoising diffusion models can be evaluated using various metrics that assess the quality and diversity of generated samples. The Inception Score (IS) is one such metric that can be used; it measures how distinguishable the generated classes are and the confidence of the classification. For example, a higher Inception Score indicates that the generated images are both diverse across classes and each image is distinctly recognized by a classifier as belonging to a specific class. Another commonly used metric is the Fréchet Inception Distance (FID), which assesses the similarity between the distribution of generated samples and real samples, based on features extracted by an Inception network. A lower FID indicates that the generated samples are more similar to the real samples, suggesting higher quality of the generated data.

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage media, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the machine-learned models 120 and/or 140 based on a set of training data 162. The training data 162 can include, for example, training examples that include source images, target images, and radiance data.

In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

FIG. 4A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 4B depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 4B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 4C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 4C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 4C, the central device data layer can communicate with a number of other components of the computing device, such as, for example, one or more sensors, a context manager, a device state component, and/or additional components. In some implementations, the central device data layer can communicate with each device component using an API (e.g., a private API).

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computer-implemented method for performing relightable view synthesis, the method comprising:
obtaining, by a computing system comprising one or more computing devices, (i) a plurality of source images that depict a scene with a source lighting and (ii) target lighting data that describes a target lighting for the scene, the target lighting being different from the source lighting;
generating, by the computing system and based on the plurality of source images, radiance data that represents radiance characteristics of the scene under the target lighting;
respectively processing, by the computing system, the plurality of source images and the radiance data with a machine-learned relighting diffusion model to respectively generate a plurality of re-lit images that depict the scene with the target lighting;
training, by the computing system, a latent neural radiance field model using the plurality of re-lit images; and
after training latent neural radiance field model, querying, by the computing system, the latent neural radiance field model to generate a synthetic image that depicts the scene with the target lighting from a novel pose.

2. The computer-implemented method of claim 1, wherein generating, by the computing system and based on the plurality of source images, the radiance data that represents radiance characteristics of the scene under the target lighting comprises:
training, by the computing system, a source neural scene representation using the plurality of source images;
after training the source neural scene representation, generating, by the computing system, scene surface information as an output of the source neural radiance field; and
processing, by the computing system, the scene surface information and the target lighting data with a rendering engine to generate the radiance data.

3. The computer-implemented method of claim 2, wherein the radiance data comprises a plurality of renderings of a surface geometry of the scene under the target lighting, wherein in the plurality of renderings the surface geometry of the scene respectively has a plurality of different material characteristics.

4. The computer-implemented method of claim 1, further comprising, prior to processing, by the computing system, the plurality of source images and the radiance data with the machine-learned relighting diffusion model:
obtaining, by the computing system, a relighting training dataset comprising a plurality of training examples, each training example comprising (i) a training source image that depicts a training scene under a training source lighting, (ii) training radiance cues that describe radiance characteristics of the training scene under a training target lighting, and (iii) a training re-lit image that depicts the training scene under the training target lighting; and
training, by the computing system, the machine-learned relighting diffusion model to generate the training re-lit image from input noise conditioned on the training source image and the training radiance cues.

5. The computer-implemented method of claim 4, wherein obtaining, by the computing system, the relighting training dataset comprises generating the relighting training dataset using a set of three-dimensional rendering assets and a rendering engine.

6. The computer-implemented method of claim 1, wherein training, by the computing system, the latent neural radiance field model using the plurality of re-lit images comprises:
respectively initializing, by the computing system, a plurality of latent variable values for the plurality of re-lit images; and
jointly optimizing, by the computing system and using the plurality of re-lit images, (i) parameter values of the latent neural radiance field model and (ii) the plurality of latent variable values for the plurality of re-lit images.

7. The computer-implemented method of claim 6, wherein querying, by the computing system, the latent neural radiance field model to generate the synthetic image comprises querying, by the computing system, the latent neural radiance field model with (i) pose data describing the novel pose and (ii) a latent variable query value.

8. The computer-implemented method of claim 1, wherein the source lighting comprises an unknown lighting.

9. A computing system comprising one or more processors and one or more non-transitory computer-readable media that collectively store instructions that when executed by the one or more processors cause the computing system to perform operations, the operations comprising:
obtaining, by the computing system comprising, (i) a plurality of source images that depict a scene with a source lighting and (ii) target lighting data that describes a target lighting for the scene, the target lighting being different from the source lighting;
generating, by the computing system and based on the plurality of source images, radiance data that represents radiance characteristics of the scene under the target lighting;
respectively processing, by the computing system, the plurality of source images and the radiance data with a machine-learned relighting diffusion model to respectively generate a plurality of re-lit images that depict the scene with the target lighting;
training, by the computing system, a latent neural radiance field model using the plurality of re-lit images; and
after training latent neural radiance field model, querying, by the computing system, the latent neural radiance field model to generate a synthetic image that depicts the scene with the target lighting from a novel pose.

10. The computing system of claim 9, wherein generating, by the computing system and based on the plurality of source images, the radiance data that represents radiance characteristics of the scene under the target lighting comprises:
training, by the computing system, a source neural scene representation using the plurality of source images;
after training the source neural scene representation, generating, by the computing system, scene surface information as an output of the source neural radiance field; and
processing, by the computing system, the scene surface information and the target lighting data with a rendering engine to generate the radiance data.

11. The computing system of claim 10, wherein the radiance data comprises a plurality of renderings of a surface geometry of the scene under the target lighting, wherein in the plurality of renderings the surface geometry of the scene respectively has a plurality of different material characteristics.

12. The computing system of claim 9, wherein the operations further comprise, prior to processing, by the computing system, the plurality of source images and the radiance data with the machine-learned relighting diffusion model:
obtaining, by the computing system, a relighting training dataset comprising a plurality of training examples, each training example comprising (i) a training source image that depicts a training scene under a training source lighting, (ii) training radiance cues that describe radiance characteristics of the training scene under a training target lighting, and (iii) a training re-lit image that depicts the training scene under the training target lighting; and
training, by the computing system, the machine-learned relighting diffusion model to generate the training re-lit image from input noise conditioned on the training source image and the training radiance cues.

13. The computing system of claim 12, wherein obtaining, by the computing system, the relighting training dataset comprises generating the relighting training dataset using a set of three-dimensional rendering assets and a rendering engine.

14. The computing system of claim 9, wherein training, by the computing system, the latent neural radiance field model using the plurality of re-lit images comprises:
respectively initializing, by the computing system, a plurality of latent variable values for the plurality of re-lit images; and
jointly optimizing, by the computing system and using the plurality of re-lit images, (i) parameter values of the latent neural radiance field model and (ii) the plurality of latent variable values for the plurality of re-lit images.

15. The computing system of claim 14, wherein querying, by the computing system, the latent neural radiance field model to generate the synthetic image comprises querying, by the computing system, the latent neural radiance field model with (i) pose data describing the novel pose and (ii) a latent variable query value.

16. The computing system of claim 9, wherein the source lighting comprises an unknown lighting.

17. One or more non-transitory computer-readable media that store a latent neural radiance field model configured to generate a synthetic image that depicts the scene with the target lighting from a novel pose, wherein the latent neural radiance field model has previously been trained by performance of training operations, the training operations comprising:
obtaining, by a computing system comprising one or more computing devices, (i) a plurality of source images that depict a scene with a source lighting and (ii) target lighting data that describes a target lighting for the scene, the target lighting being different from the source lighting;
generating, by the computing system and based on the plurality of source images, radiance data that represents radiance characteristics of the scene under the target lighting;
respectively processing, by the computing system, the plurality of source images and the radiance data with a machine-learned relighting diffusion model to respectively generate a plurality of re-lit images that depict the scene with the target lighting; and
training, by the computing system, the latent neural radiance field model using the plurality of re-lit images.

18. The one or more non-transitory computer-readable media of claim 17, wherein generating, by the computing system and based on the plurality of source images, the radiance data that represents radiance characteristics of the scene under the target lighting comprises:
training, by the computing system, a source neural scene representation using the plurality of source images;
after training the source neural scene representation, generating, by the computing system, scene surface information as an output of the source neural radiance field; and
processing, by the computing system, the scene surface information and the target lighting data with a rendering engine to generate the radiance data.

19. The one or more non-transitory computer-readable media of claim 17, wherein the training operations further comprise, prior to processing, by the computing system, the plurality of source images and the radiance data with the machine-learned relighting diffusion model:
obtaining, by the computing system, a relighting training dataset comprising a plurality of training examples, each training example comprising (i) a training source image that depicts a training scene under a training source lighting, (ii) training radiance cues that describe radiance characteristics of the training scene under a training target lighting, and (iii) a training re-lit image that depicts the training scene under the training target lighting; and
training, by the computing system, the machine-learned relighting diffusion model to generate the training re-lit image from input noise conditioned on the training source image and the training radiance cues.

20. The one or more non-transitory computer-readable media of claim 17, wherein training, by the computing system, the latent neural radiance field model using the plurality of re-lit images comprises:
respectively initializing, by the computing system, a plurality of latent variable values for the plurality of re-lit images; and
jointly optimizing, by the computing system and using the plurality of re-lit images, (i) parameter values of the latent neural radiance field model and (ii) the plurality of latent variable values for the plurality of re-lit images.
